(19) United States
(12) Patent Application Publication
(10) Pub. No.: US 2017/0220131 A1
(43) Pub. Date: Aug. 3, 2017

(54) METHOD FOR CONTROLLING OPERATIONS OF AN ELECTRONIC DEVICE THROUGH AMBIENT LIGHT DETECTION, AND ASSOCIATED APPARATUS

(71) Applicant: MEDIATEK INC., Hsin-Chu (TW)

(72) Inventors: Yong-Zhi Huang, New Taipei City (TW); Chun-An Lai, Taipei City (TW)

(21) Appl. No.: 15/201,513

(22) Filed: Jul. 4, 2016

Related U.S. Application Data
(60) Provisional application No. 62/290,493, filed on Feb. 3, 2016.

(51) Int. Cl. G06F 3/03; G06K 9/00

(52) U.S. Cl. CPC G06F 3/0304; G06K 9/00496

(57) ABSTRACT

A method for controlling operations of an electronic device through ambient light detection and associated apparatus are provided, where the method includes: utilizing an ambient light sensor of the electronic device to detect ambient light for the electronic device, to generate an ambient light detection signal, sampling the ambient light detection signal to convert the ambient light detection signal into a converted signal, and performing pattern detection on the converted signal to detect at least one pattern of the converted signal; and according to a pattern and event database, determining whether the detected pattern of the converted signal matches a predetermined pattern within a plurality of predetermined patterns, to selectively trigger a predetermined operation associated with the predetermined pattern, wherein the pattern and event database stores the plurality of predetermined patterns.

### CROSS REFERENCE TO RELATED APPLICATIONS

This application claims the benefit of U.S. Provisional Application No. 62/290,493, which was filed on Feb. 3, 2016, and is included herein by reference.

### BACKGROUND

The present invention relates to activating operations of an electronic device, and more particularly, to a method for controlling operations of an electronic device through ambient light detection, and an associated apparatus. For example, as a result of implementing the electronic device according to the method and the apparatus, operations of the electronic device may be activated through touchless input using an ambient light sensor.

According to the related art, a conventional electronic device that is equipped with a touch input module and/or a keyboard, such as a conventional multifunctional mobile phone, may be designed to receive inputs from the user via the touch input module and/or the keyboard. However, some problems may occur. For example, in a situation where both hands of the user are dirty and the user wants to do something with the electronic device (e.g. answering a phone call from somebody important during repairing a machine), the user may be forced to go somewhere to wash his/her hands, in order to prevent the touch input module from becoming dirty. In another example, in a situation where both hands of the user are wet and the user wants to do something with the electronic device (e.g. reading a recipe during cooking), the user may be forced to go finding a towel to dry his/her hands or fingers, in order to prevent the touch input module from becoming wet. Thus, a novel method and a corresponding architecture are required to improve user experience of electronic devices.

### SUMMARY

It is an objective of the claimed invention to provide a method for controlling operations of an electronic device through ambient light detection, and an associated apparatus, in order to solve the above-mentioned problems.

It is another objective of the claimed invention to provide a method for controlling operations of an electronic device through ambient light detection, and an associated apparatus, in order to enhance user experience of electronic devices.

According to at least one preferred embodiment, a method for controlling operations of an electronic device through ambient light detection is provided, where the method may comprise the steps of: utilizing an ambient light sensor of the electronic device to detect ambient light for the electronic device, to generate an ambient light detection signal, sampling the ambient light detection signal to convert the ambient light detection signal into a converted signal (e.g. a digital signal or an analog signal), and performing pattern detection on the converted signal to detect at least one pattern of the converted signal, wherein the converted signal may carry samples of the ambient light detection signal; and according to a pattern and event database, determining whether the detected pattern of the converted signal matches a predetermined pattern within a plurality of predetermined patterns, to selectively trigger (e.g. trigger or not trigger) a predetermined operation associated with the predetermined pattern, wherein the pattern and event database stores the plurality of predetermined patterns. More particularly, the pattern and event database may store a plurality of predetermined relationships between the plurality of predetermined patterns and a plurality of predetermined operations, where the predetermined operations are associated with the predetermined patterns, respectively. For example, the step of determining whether the detected pattern of the converted signal matches the predetermined pattern within the plurality of predetermined patterns to selectively trigger the predetermined operation associated with the predetermined pattern may further comprise: when it is detected that the detected pattern matches the predetermined pattern, triggering the predetermined operation associated with the predetermined pattern.

According to at least one preferred embodiment, an apparatus for controlling operations of an electronic device through ambient light detection is provided, where the apparatus may comprise at least one portion (e.g. a portion or all) of an electronic device. For example, the apparatus may comprise an ambient light sensor and a processing circuit that are positioned in the electronic device, wherein the ambient light sensor and the processing circuit are coupled to each other. The processing circuit may comprise a converter, a pattern detection and trigger unit, and a pattern and event database. The ambient light sensor may be arranged for detecting ambient light for the electronic device, to generate an ambient light detection signal, and the processing circuit may be arranged for controlling the electronic device, for example, by using the converter, the pattern detection and trigger unit, and the pattern and event database. The processing circuit (e.g. the converter) may be arranged for sampling the ambient light detection signal to convert the ambient light detection signal into a converted signal (e.g. a digital signal or an analog signal), wherein the converted signal may carry samples of the ambient light detection signal. In addition, the processing circuit (e.g. the pattern detection and trigger unit) may be arranged for performing pattern detection on the converted signal to detect at least one pattern of the converted signal. Additionally, the pattern and event database may be arranged for storing a plurality of predetermined patterns. For example, the pattern and event database may store a plurality of predetermined relationships between the plurality of predetermined patterns and a plurality of predetermined operations, where the predetermined operations are associated with the predetermined patterns, respectively. According to the pattern and event database, the processing circuit (e.g. the pattern detection and trigger unit) may determine whether the detected pattern of the converted signal matches a predetermined pattern within the plurality of predetermined patterns, to selectively trigger (e.g. trigger or not trigger) a predetermined operation associated with the predetermined pattern. For example, when it is detected that the detected pattern matches the predetermined pattern, the pattern detection and trigger unit may trigger the predetermined operation associated with the predetermined pattern.

It is an advantage of the present invention that the present invention method and apparatus can enhance user experience of electronic devices in each of various situations, and the related art problems may no longer be an issue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for controlling operations of an electronic device through ambient light detection according to an embodiment of the present invention.

FIG. 2 illustrates some control phases involved with the apparatus shown in FIG. 1 according to an embodiment of the present invention.

FIG. 3 illustrates a flowchart of a method for controlling operations of an electronic device through ambient light detection according to an embodiment of the present invention.

FIG. 4 illustrates a triggering control scheme involved with the method shown in FIG. 3 according to an embodiment of the present invention.

FIG. 5 illustrates a detection result corresponding to one of different touchless inputs involved with the method shown in FIG. 3 according to an embodiment of the present invention.

FIG. 6 illustrates a detection result corresponding to one of different touchless inputs involved with the method shown in FIG. 3 according to another embodiment of the present invention.

FIG. 7 illustrates a detection result corresponding to one of different touchless inputs involved with the method shown in FIG. 3 according to yet another embodiment of the present invention.

FIG. 8 illustrates a data delivery control scheme involved with the method shown in FIG. 3 according to an embodiment of the present invention.

FIG. 9 illustrates a data broadcasting control scheme involved with the method shown in FIG. 3 according to an embodiment of the present invention.

FIG. 10 illustrates a data broadcasting control scheme involved with the method shown in FIG. 3 according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

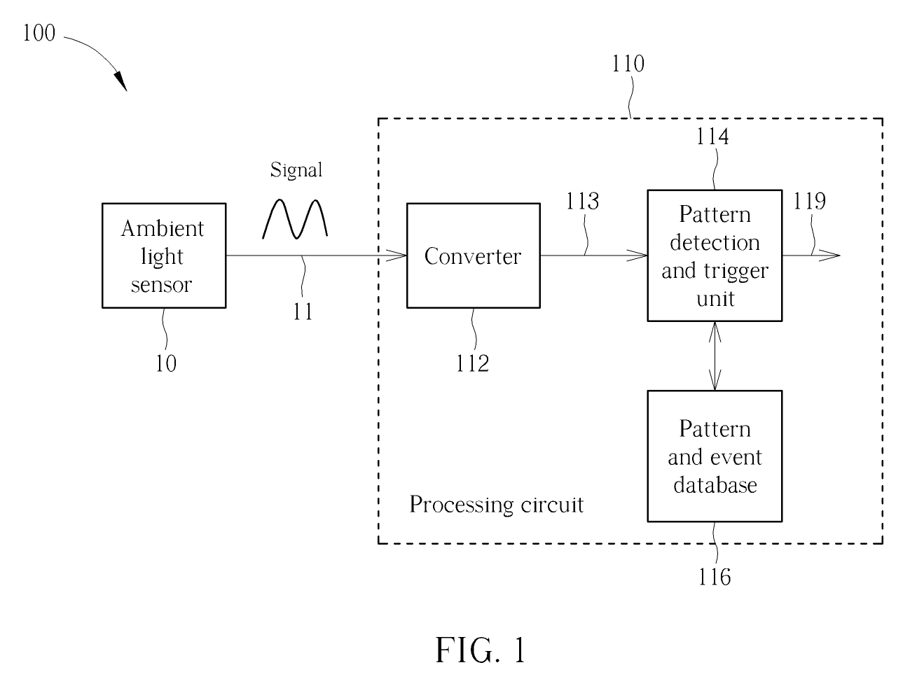

FIG. 1 is a diagram of an apparatus 100 for controlling operations of an electronic device through ambient light detection according to an embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device and associated circuits thereof. In another example, the apparatus 100 can be the whole of the electronic device mentioned above. In another example, the apparatus 100 may comprise a system comprising the electronic device mentioned above (e.g. a wireless communications system comprising the electronic device). Examples of the electronic device may include, but not limited to, a mobile phone (e.g. a multifunctional mobile phone), a tablet, a wearable device, an Internet of Things (IoT) device and a personal computer such as a laptop computer or a desktop computer.

As shown in FIG. 1, the apparatus 100 may comprise an ambient light sensor 10 and a processing circuit 110 that are both positioned in the electronic device, and the processing circuit 110 may comprise a converter 112, a pattern detection and trigger unit 114, and a pattern and event database 116, where the ambient light sensor 10 and the processing circuit 110 may be coupled to each other. For example, the electronic device may comprise at least one processor, and at least one portion (e.g. a portion or all) of the processing circuit 110 may be implemented within the aforementioned at least one processor. In one example, the converter 112 may comprise a sampler circuit and/or an analog-to-digital converter (ADC). In addition, the pattern detection and trigger unit 114 can be implemented with a program module running on the aforementioned at least one processor. Additionally, the pattern and event database 116 can be implemented with a storage unit such as a non-volatile memory (e.g. a Flash memory).

According to this embodiment, the ambient light sensor 10 may detect the ambient light for the electronic device, to generate an ambient light detection signal 11. For example, the ambient light sensor 10 may detect the light intensity of the ambient light, and the ambient light detection signal 11 may indicate the light intensity variations. The processing circuit 110 may be arranged for controlling the electronic device, for example, by using the converter 112, the pattern detection and trigger unit 114, and the pattern and event database 116. The converter 112 may sample the ambient light detection signal 11 to convert the ambient light detection signal 11 into a converted signal. The converted signal may carry samples of the ambient light detection signal 11, and therefore the converted signal or a derivative thereof may indicate a meaningful input corresponding to the ambient light. For example, the meaningful input may be a pattern of the converted signal with respect to time. In addition, the pattern detection and trigger unit 114 may perform pattern detection on the converted signal to detect at least one pattern (e.g. one or more patterns) of the converted signal, and may find the meaningful input such as the aforementioned pattern of the converted signal with respect to time. For example, according to the pattern and event database 116, the pattern detection and trigger unit 114 may determine whether the detected pattern of the converted signal (e.g. the aforementioned at least one pattern of the converted signal, such as the meaningful input mentioned above) matches one of a plurality of predetermined patterns. Please note that the converted signal may be an analog signal or a digital signal in different embodiments. For example, in a situation where the converted signal is the digital signal, an analog-to-digital converter (ADC) may be required for generating the converted signal such as the digital signal and the ADC may be positioned within the converter 112. In some examples, in a situation where the converted signal is the analog signal, it may be unnecessary to implement an ADC such as that mentioned above.

According to the embodiment shown in FIG. 1, a digital signal 113 can be taken as an example of the converted signal mentioned above. For example, the digital signal 113 may carry the samples of the ambient light detection signal 11, and therefore the digital signal 113 or a derivative thereof may indicate the aforementioned meaningful input corresponding to the ambient light. For example, the meaningful input may be a pattern of the digital signal with respect to time. In addition, the pattern detection and trigger unit 114 may perform pattern detection on the digital signal 113 to detect the aforementioned at least one pattern of the converted signal, such as at least one pattern (e.g. one or more patterns, which may also be referred to as the pattern(s), for brevity) of the digital signal 113, and may find the meaningful input such as the pattern of the digital signal with respect to time. According to this embodiment, the pattern and event database 116 may store the plurality of predetermined patterns, and more particularly, may store a plurality of predetermined relationships between the plurality of predetermined patterns and a plurality of predetermined operations, where the predetermined operations may be associated with the predetermined patterns, respectively. For example, the pattern and event database 116 may comprise a mapping table storing the plurality of predetermined relationships. According to the pattern and event database 116, the pattern detection and trigger unit 114 may determine whether the detected pattern of the digital signal (e.g. the aforementioned at least one pattern of the digital signal 113, such as the meaningful input mentioned above) matches a predetermined pattern within the plurality of predetermined patterns. When it is detected that the detected pattern matches this predetermined pattern, the pattern detection and trigger unit 114 may trigger a predetermined operation associated with this predetermined pattern. For example, the pattern detection and trigger unit 114 may send a command 119 corresponding to this predetermined operation, to trigger this predetermined operation.

According to some embodiments, such as the embodiment shown in FIG. 1, at least one portion (e.g. a portion or all) of operations of the components shown in FIG. 1, such as at least one portion of the operation performed by the ambient light sensor 10, at least one portion of the operation performed by the converter 112, and at least one portion of the operation performed by the pattern detection and trigger unit 114, may be performed at the same time. For example, when the ambient light sensor 10 is generating the ambient light detection signal 11, the converter 112 may convert the ambient light detection signal 11 into the converted signal in real time. Besides, the one of the plurality of predetermined patterns may comprise a predetermined sequence of a plurality of predetermined logical values, such as a predetermined bit sequence of a plurality of predetermined bits. In one example, the converter 112 may generate and output the samples toward the pattern detection and trigger unit 114 one by one, and the pattern detection and trigger unit 114 may compare the samples with the plurality of predetermined logical values (e.g. the plurality of predetermined bits) one by one. This is for illustrative purposes only, and is not meant to be a limitation of the present invention. In another example, the converter 112 may generate and output a first set of samples within the samples toward the pattern detection and trigger unit 114, the pattern detection and trigger unit 114 may compare the first set of samples with a first set of predetermined logical values within the plurality of predetermined logical values (e.g. a first set of predetermined bits within the plurality of predetermined bits), respectively. For another example, the converter 112 may send the samples toward the pattern detection and trigger unit 114 in units of a predetermined number of samples. In addition, when the converter 112 has generated a set of samples with the number of this set of samples being equivalent to the predetermined number (e.g. a predetermined value), the converter 112 may output this set of samples toward the pattern detection and trigger unit 114, and then the pattern detection and trigger unit 114 may compare this set of samples with a set of predetermined logical values within the plurality of predetermined logical values (e.g. a set of predetermined bits within the plurality of predetermined bits), respectively.

In some embodiment, the pattern detection and trigger unit 114 can be implemented with a customized hardware circuit such as an application-specific integrated circuit (ASIC). For example, the converter 112 may be integrated into the customized hardware circuit such as the ASIC. In some embodiment, the pattern and event database 116 can be implemented with a storage device of the electronic device, such as a solid state drive (SSD) or a hard disk drive (HDD).

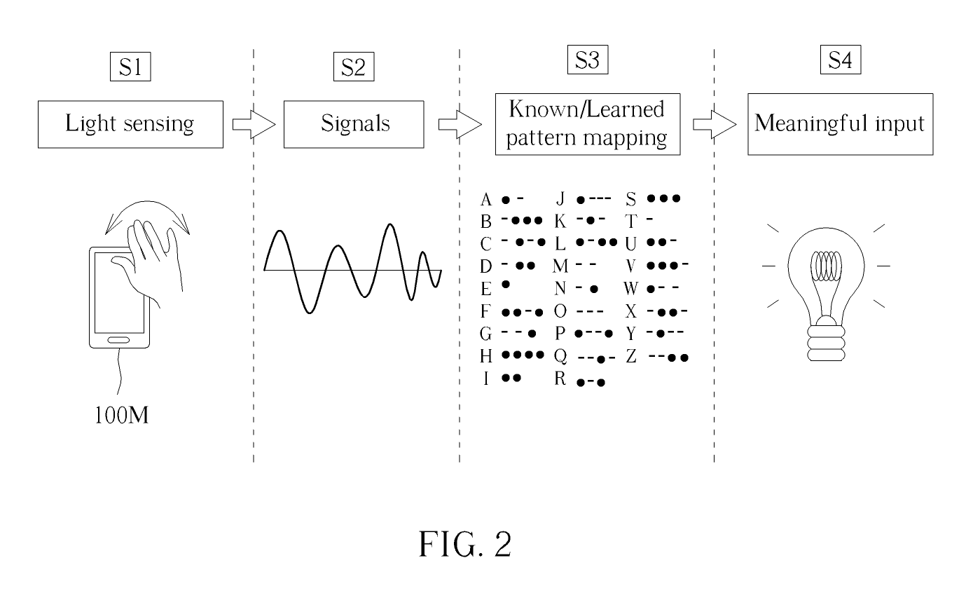

FIG. 2 illustrates some control phases S1, S2, S3, and S4 involved with the apparatus 100 shown in FIG. 1 according to an embodiment of the present invention, where the multifunctional mobile phone 100M can be taken as an example of the electronic device. In the control phase S1, the ambient light sensor 10 may perform light sensing. For example, the user of the electronic device may apply a touchless input to the electronic device (e.g. by shaking his/her hand around the ambient light sensor 10), and the ambient light may vary with respect to time, so the ambient light detection signal 11 generated by the ambient light sensor 10 may vary in response to the touchless input. As a result, in the control phase S2, the converter 112 may perform signal conversion (i.e. the conversion between signals, labeled “Signals” in FIG. 2 for brevity). For better comprehension, a waveform is illustrated to indicate that the ambient light detection signal 11 may carry the light intensity variations. This is for illustrative purposes only, and is not meant to be a limitation of the present invention. Please note that, when the user is applying the touchless input to the electronic device, the converter 112 may perform the analog-to-digital conversion in real time.

As shown in FIG. 2, in the control phase S3, the pattern detection and trigger unit 114 may perform known or learned pattern mapping (labeled “Known/Learned pattern mapping” in FIG. 2, for brevity). For example, in a situation where known pattern mapping is performed, the plurality of predetermined patterns may comprise some predetermined codes such as at least one portion (e.g. a portion or all) of the Morse code illustrated in FIG. 2. According to some embodiments, in a situation where learned pattern mapping is performed, the plurality of predetermined patterns may comprise some learned patterns such as that generated by learning or training. For example, the user of the electronic device may perform a first gesture to be saved as a first pattern of the learned patterns and the user may correspond a first operation to the first pattern, then the relationship between the first pattern and the first operation may be saved in the pattern and event database 116. In another example, the processing circuit 110 may control a display module (e.g. a touch-sensitive display module such as a touch screen) of the electronic device to display a hint, for guiding the user to apply a touchless input such as that mentioned above to the electronic device and guiding the user to determining the setting(s) regarding the operation to be triggered through this touchless input, where the processing circuit 110 may utilize the pattern detection and trigger unit 114 to perform pattern detection for learning or training purposes. As a result, the processing circuit 110 may control the electronic device to learn the touchless input by storing the associated pattern as one of the plurality of predetermined patterns. According to this embodiment, in the control phase S4, the pattern detection and trigger unit 114 may find the meaningful input mentioned above (e.g. the shining light bulb shown in FIG. 2 may indicated that the meaningful input is found), and therefore may trigger the predetermined operation mentioned above (e.g. by sending the command 119). For example, in a situation where both hands of the user are dirty or wet and the user wants to do something with the electronic device, the processing circuit 110 may control the electronic device to perform the predetermined operation, and the user does not need to touch the touch input module.

As the ambient light sensor 10 may have been designed to detect the ambient light for other purposes of controlling the electronic device, the ambient light sensor 10 is an essential component of the electronic device. By utilizing a single sensor such as the ambient light sensor 10 to detect the ambient light for the electronic device to generate the ambient light detection signal 11 for performing pattern detection, the present invention can be implemented without additional hardware component(s). For example, the processing circuit 110 (e.g. the pattern detection and trigger unit 114) may perform pattern detection with aid of the single sensor such as the ambient light sensor 10, rather than any other sensor. Therefore, the associated material and labor costs for manufacturing the electronic device can be saved.

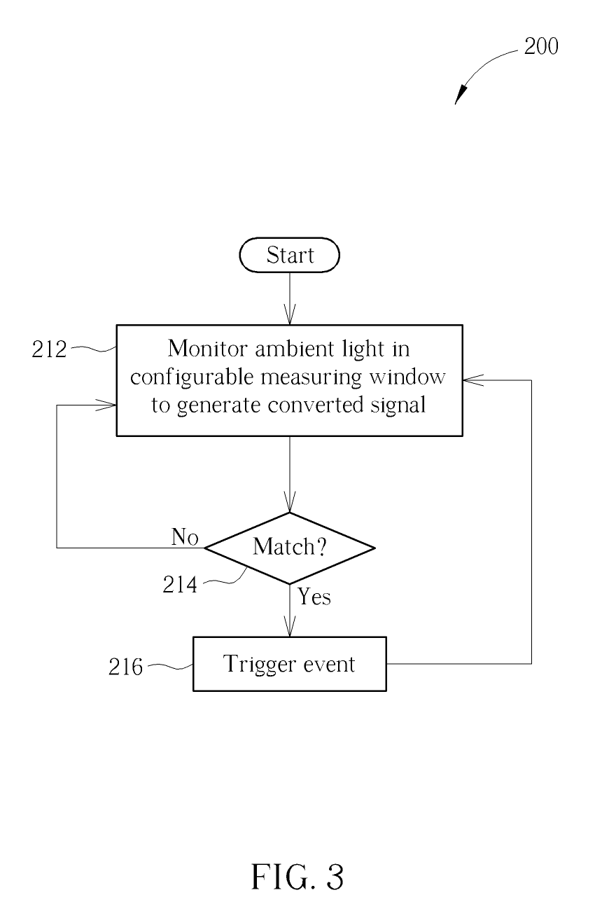

FIG. 3 illustrates a flowchart of a method 200 for controlling operations of an electronic device through ambient light detection according to an embodiment of the present invention.

In Step 212, by utilizing a sensor such as the ambient light sensor 10, the processing circuit 110 may monitor the ambient light in a configurable measuring window (e.g. a measuring window having a window size that is configurable along the time axis), to generate the converted signal (e.g. the digital signal 113). For example, the processing circuit 110 (e.g. the converter 112 therein) may sample the ambient light detection signal 11 to convert the ambient light detection signal 11 into an initial version of the converted signal, and may normalize the initial version of the converted signal to generate a normalized signal and utilize the normalized signal as the converted signal. For example, the average light intensity of the ambient light may vary indifferent hours of a day. By normalizing original samples carried by the initial version of the converted signal into normalized samples carried by the normalized signal, the pattern detection can be performed more accurately.

In Step 214, according to the pattern and event database 116, the processing circuit 110 (e.g. the pattern detection and trigger unit 114 therein) may determine whether the detected pattern, such as the latest detected pattern that is detected according to the normalized samples just obtained in Step 212, matches the predetermined pattern. When the detected pattern matches the predetermined pattern, Step 216 is entered; otherwise (e.g. the latest detected pattern that is detected according to the normalized samples just obtained in Step 212 does not match any of the plurality of predetermined patterns), Step 212 is re-entered.

In Step 216, the processing circuit 110 (e.g. the pattern detection and trigger unit 114 therein) may trigger an associated event, such as the predetermined operation associated with the predetermined pattern.

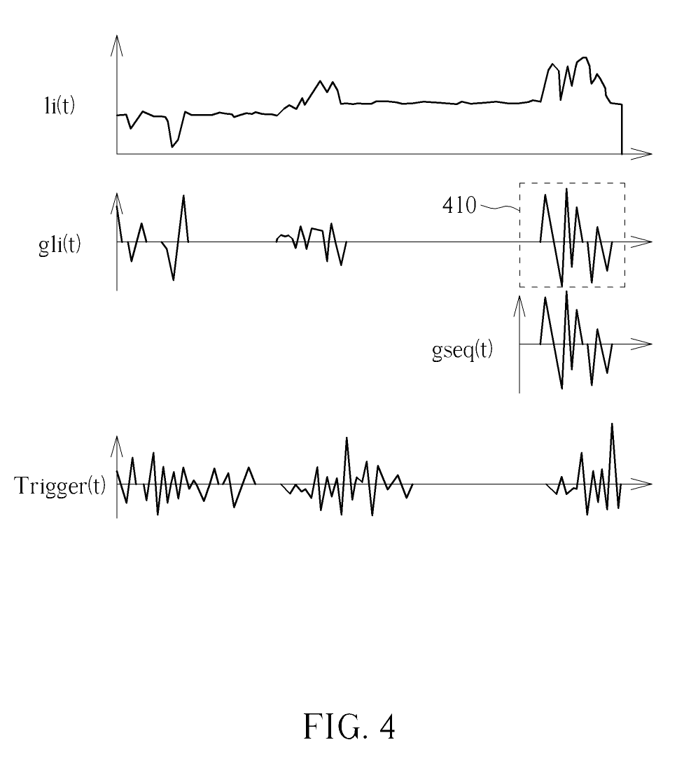

FIG. 4 illustrates a triggering control scheme involved with the method 200 shown in FIG. 3 according to an embodiment of the present invention. For example, the function li(t) may represent the light intensity (e.g. the light intensity data carried by the digital signal 113) with respect to time, where the notation “t” stands for time. In addition, the function gli(t) may represent the gradient of the light intensity with respect to time (e.g. the gradient of the function li(t)), and therefore can be regarded as the light intensity gradient signal having the light intensity gradient patterns. Additionally, the curve of the function gseq(t) may represent the predetermined pattern, and the curve of the function Trigger(t) may represent a similarity index.

According to this embodiment, before performing pattern detection, the processing circuit 110 (e.g. the pattern detection and trigger unit 114 therein) may perform a pre-processing operation on the digital signal 113 to generate a derivative of the digital signal 113 (such as the aforementioned derivative of the digital signal 113 in the embodiment shown in FIG. 1), where the derivative of the digital signal 113 may indicate the meaningful input corresponding to the ambient light. For example, the pre-processing operation may comprise calculating the gradient of the light intensity with respect to time (e.g. calculating the gradient of the function li(t)), to generate the derivative of the digital signal 113. For example, the processing circuit 110 (e.g. the pattern detection and trigger unit 114 therein) may calculate the gradient of the function li(t) to generate data of the function gli(t) in real time, and calculate the similarity between a partial curve within the curve of the function gli (t) (e.g. the partial curve within a sliding window having the same window size as that of the configurable measuring window mentioned in Step 212) and the curve of the function gseq(t), to generate data of the function Trigger(t). As shown in FIG. 4, a portion of the curve of the function gli(t), such as the partial curve 410 around the rightmost, is substantially equivalent to the curve of the function gseq(t). As a result, when the similarity index reach a predetermined threshold at a time point (e.g. the time point corresponding to the maximum of the function Trigger(t) in this embodiment), the detected pattern corresponding to the partial curve 410 can be identified as the predetermined pattern.

According to some embodiments, the raw data of the light intensity data carried by the digital signal 113 can be pre-processed by applying one or more of a plurality of filters (e.g. a Kalman filter, a Gaussian filter, a moving average filter, etc.) to reduce the noise and extract specific features.

According to some embodiments, based on the function li(t), the pattern detection and trigger unit 114 may obtain the partial curve 410 in a time interval [a, b] from the curve of the function gli(t) by using the sliding window having the window size of (b-a), starting from the time point a. For example, the pattern detection and trigger unit 114 may normalize the gradient pattern corresponding to the partial curve 410 to be a normalized vector. Examples of the plurality of predetermined patterns may include, but not limited to, some pre-defined sequences which are assigned to or associated with certain meaningful inputs, respectively, such as:

seq(t, k, d);
where the notation “k” is a sequence index indicating a sequence within the pre-defined sequences, and the notation “d” represents the duration of the time interval [a(k), b(k)]. Based on the sequence seq(t, k, d), the pattern detection and trigger unit 114 may get its gradient and its gradient pattern such as the gradient sequence gseq(t, k, d). In some embodiments, the pattern detection and trigger unit 114 may calculate and get the gradient of gli(t), such as ggli(t), and the gradient of gseq(t, k, d), such as ggseq(t, k, d), for pattern detection.

According to some embodiments, based on the function li(t), the pattern detection and trigger unit 114 may monitor the ambient light in the measuring window for mapping to one of the known patterns in an iterative process. Base on the previous definitions regarding the functions li(t), gli(t), and ggli(t) and the sequences seq(t, k, d), gseq(t, k, d), and ggseq(t, k, d), the pattern detection and trigger unit 114 may perform pattern detection according to one or more of some existing method, such as similarity/distance measurement methods, known pattern recognition methods, and neural network recognition methods, etc., to find out whether one or more of the following conditions are satisfied at a time point ta:

(A). li(t) is similar to seq(ta, k, d);
(B). gli(t) is similar to gseq(ta, k, d); and
(C). ggli(t) is similar to ggseq(ta, k, d);
where one or more of the conditions (A), (B), and (C) may indicate that the detected pattern matches the predetermined pattern. For example, the pattern detection and trigger unit 114 may decide when to trigger one of the events (such as the event mentioned in the Step 216) according to the conditions (B) or (C) (e.g. the condition (B) or the condition (C) is satisfied), or according to the conditions (A) and (B) (e.g. both of the conditions (A) and (B) are satisfied), or according to the conditions (A), (B), and (C) (e.g. all of the conditions (A), (B), and (C) are satisfied), or according to one or more Boolean combinations of the above.

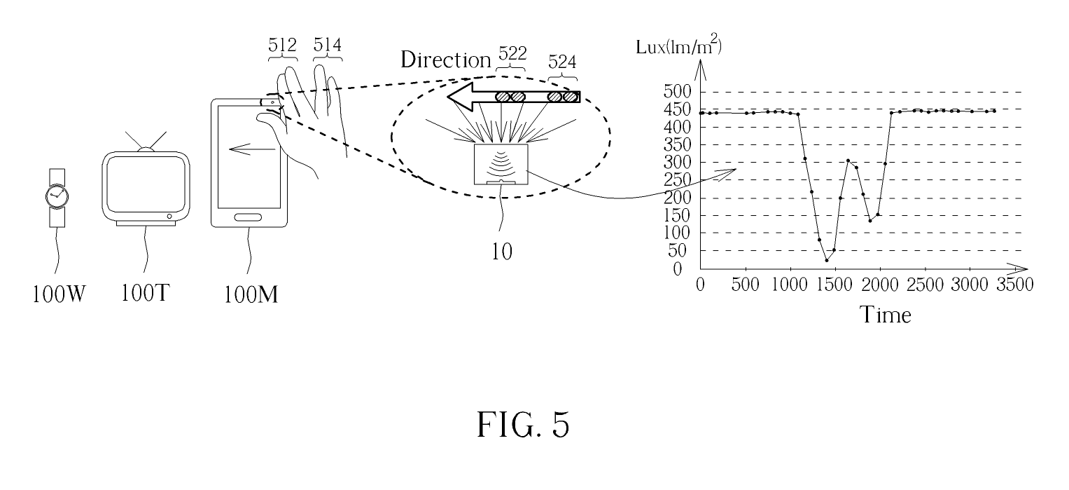

FIG. 5 illustrates a detection result (e.g. the curve shown in the rightmost of FIG. 5) corresponding to one of different touchless inputs involved with the method 200 shown in FIG. 3 according to an embodiment of the present invention. For example, the electronic device can be a watch 100W, a television (TV) 100T, the multifunctional mobile phone 100M, an IoT device, etc., where the apparatus 100 may comprise at least one portion (e.g. a portion or all) of the electronic device. Taking the multifunctional mobile phone 100M as an example, the user may intentionally put at least one portion (e.g. a portion or all) of the fingers of one of his/her hand into a plurality of finger sets (each set of which may comprise one or more fingers) such as the finger sets 512 and 514 and slide this hand on a predetermined path such as that corresponding to the direction shown in FIG. 5. As a result, the light intensity variations may correspond to the shade of the finger sets 512 and 514 along the predetermined path, and the light intensity data carried by the digital signal 113 may indicate the light intensity variations (e.g. variations of the curve of the function li(t), such as that of the curve shown in the rightmost of FIG. 5). For example, when the detected pattern matches the predetermined pattern such as a specific pattern corresponding to the plurality of finger sets within the measuring window, the pattern detection and trigger unit 114 may trigger the corresponding event or the corresponding control action, through the command 119.

Please note that, for the ambient light sensor 10 shown in FIG. 5, each moving finger in the moving fingers sets 522 and 524 (i.e. the finger sets 512 and 514 that are moving) seems to have a width different from that of the corresponding finger in the finger sets 512 and 514, since the scale may vary in response to the speed of the moving finger. In addition, the user may move this hand at a constant speed, and one moving finger in the moving fingers sets 522 and 524 may seem to have the same width as that of another moving finger in the moving fingers sets 522 and 524. For example, in a situation where the aforementioned learned pattern mapping is performed, the plurality of predetermined patterns may comprise the learned patterns such as that generated by learning or training, and the processing circuit 110 may control the display module of the electronic device to display a hint, for guiding the user to apply a touchless input such as that of this embodiment (e.g. by moving the plurality of finger sets along the predetermined path, at the constant speed) to the electronic device so that a corresponding operation can be triggered. For brevity, similar descriptions for this embodiment are not repeated in detail here.

In some embodiments, the user may move this hand at variable speed(s), and one moving finger in the moving fingers sets 522 and 524 may seem to have a width different from that of another moving finger in the moving fingers sets 522 and 524. For example, in a situation where the aforementioned learned pattern mapping is performed, the plurality of predetermined patterns may comprise the learned patterns such as that generated by learning or training, and the processing circuit 110 may control the display module of the electronic device to display a hint, for guiding the user to apply a touchless input such as that of these embodiments (e.g. by moving the plurality of finger sets along the predetermined path, at the variable speed(s)) to the electronic device so that a corresponding operation can be triggered. For brevity, similar descriptions for these embodiments are not repeated in detail here.

As shown in FIG. 5, the predetermined path can be a direct path corresponding to a direct line. Thus, the predetermined path may be a one-dimensional (1D) path. In some embodiments, the predetermined path may vary, and is not limited to be a 1D path. For example, the predetermined path can be one of varies types of paths, such as an arc path corresponding to an arc, a spiral path corresponding to a spiral, etc. Thus, the predetermined path may be a two-dimensional (2D) path in these embodiments. For brevity, similar descriptions for these embodiments are not repeated in detail here.

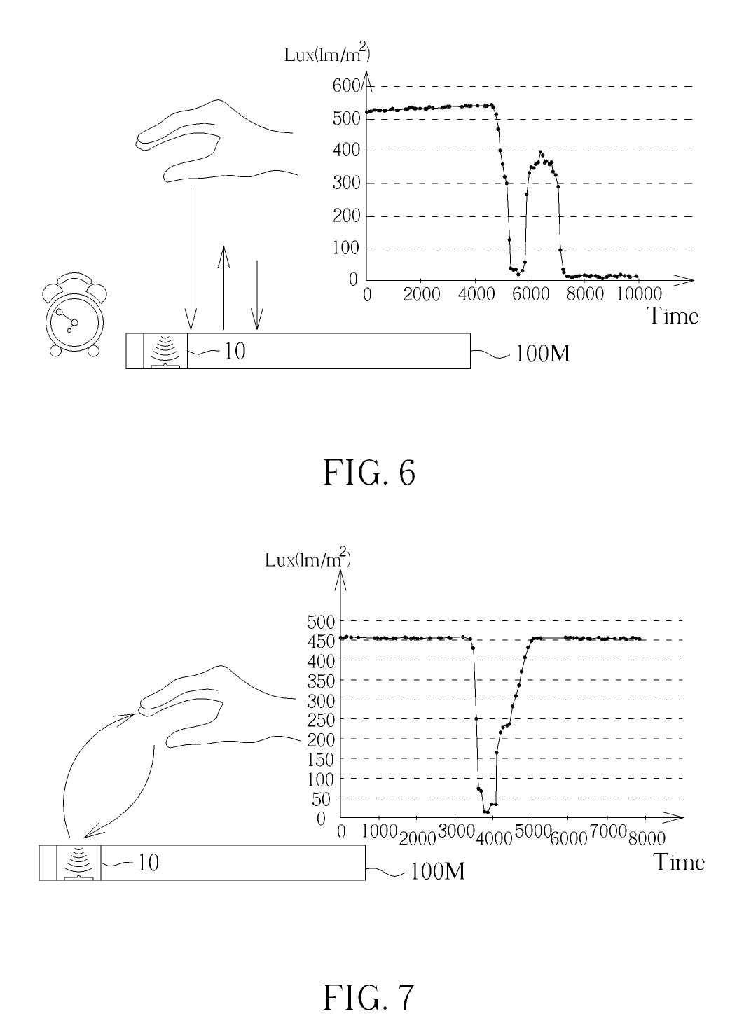

FIG. 6 illustrates a detection result (e.g. the curve shown in the rightmost of FIG. 6) corresponding to one of different touchless inputs involved with the method 200 shown in FIG. 3 according to another embodiment of the present invention. For example, the user may move his/her hand down, and then up, and then down, in order to trigger a control action of the multifunctional mobile phone 100M, such as alarm on (illustrated with the alarm notation in the leftmost of FIG. 6, for better comprehension). The light intensity variations may correspond to the touchless input of this embodiment, and the light intensity data carried by the digital signal 113 may indicate the light intensity variations (e.g. variations of the curve of the function li(t), such as that of the curve shown in the rightmost of FIG. 6). For example, when the detected pattern matches the predetermined pattern such as a specific pattern corresponding to the touchless input of this embodiment, the pattern detection and trigger unit 114 may trigger this control action. For brevity, similar descriptions for this embodiment are not repeated in detail here.

According to some embodiments, the user may move his/her hand in one of various manners. For example, the user may move his/her hand down and up, up and down, forward or backward, left or right, or any combination of the above during applying this touchless input to the multifunctional mobile phone 100M. According to some embodiments, the user may move his/her hand in one of various manners, along the predetermined path which may be a 1D path, 2D path, or a three-dimensional (3D) path in these embodiments. For brevity, similar descriptions for these embodiments are not repeated in detail here.

FIG. 7 illustrates a detection result (e.g. the curve shown in the rightmost of FIG. 7) corresponding to one of different touchless inputs involved with the method 200 shown in FIG. 3 according to yet another embodiment of the present invention. For example, the user may move his/her hand down and then up along an arc path, in order to trigger another control action of the multifunctional mobile phone 100M, such as alarm off (e.g. the alarm notation in the leftmost of FIG. 6 is not illustrated in FIG. 7, for better comprehension). The light intensity variations may correspond to the touchless input of this embodiment, and the light intensity data carried by the digital signal 113 may indicate the light intensity variations (e.g. variations of the curve of the function li(t), such as that of the curve shown in the rightmost of FIG. 7). For example, when the detected pattern matches the predetermined pattern such as a specific pattern corresponding to the touchless input of this embodiment, the pattern detection and trigger unit 114 may trigger this control action. For brevity, similar descriptions for this embodiment are not repeated in detail here.

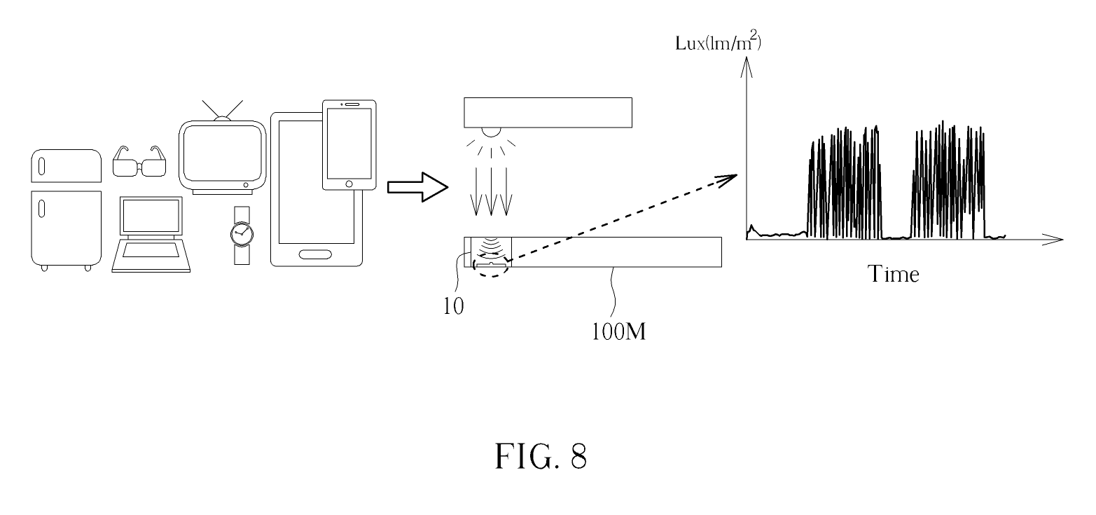

FIG. 8 illustrates a data delivery control scheme involved with the method shown in FIG. 3 according to an embodiment of the present invention. Based on the data delivery control scheme, data (e.g. text data, Universal Resource Identifier (URI), etc.) can be delivered from one device to another device within a plurality of devices, via light in pre-defined pattern combinations that represent the data. The light may come from the flash light of one device, screen of the one device, etc. According to this embodiment, at least one of the plurality of devices can be implemented according to the apparatus 100 shown in FIG. 1 and the associated method 200. Examples of the plurality of devices may include, but not limited to, various types of electronic devices such as those shown around the leftmost of FIG. 8 (e.g. a refrigerator, glasses, a laptop computer, a TV such as the TV 100T, a watch such as the watch 100W, a tablet, a mobile phone such as the multifunctional mobile phone 100M).

During data delivery, the one device within the plurality of devices may play the role of a data transmitter device, and the other device within the plurality of devices may play the role of a data receiver device. As shown in FIG. 8, the multifunctional mobile phone 100M can be taken as an example of the data receiver device. For example, the data transmitter device may comprise a light emitting component (e.g. a light emitting diode (LED), a screen, or any of other types of emitting components), and may deliver the data to the data receiver device through the light output from the light emitting component. Based on at least one portion (e.g. a portion or all) of the plurality of predetermined patterns, such as a set of pre-defined patterns, the data transmitter device may modulate the intensity of the light (of the light emitting component) according to the data, so the intensity of the light that varies with respect to time may carry the data. For example, the pre-defined pattern combinations may comprise one or more combinations of the set of pre-defined patterns, and a set of predetermined patterns within the plurality of predetermined patterns can be utilized as the set of pre-defined patterns. As the pattern detection and trigger unit 114 is capable of performing pattern detection to determine whether the detected pattern matches one of the plurality of predetermined pattern, the pattern detection and trigger unit 114 has the capability of detecting any of the aforementioned one or more combinations of the set of pre-defined patterns, and may perform demodulation to reproduce the data and store the data for further use. For brevity, similar descriptions for this embodiment are not repeated in detail here.

According to some embodiments, the aforementioned at least one portion of the plurality of predetermined patterns comprises the set of pre-defined patterns, and another portion of the plurality of predetermined patterns may comprise the learned patterns such as that generated by learning or training. For brevity, similar descriptions for these embodiments are not repeated in detail here.

According to some embodiments, the modulation and demodulation of the data delivery control scheme can be implemented with the Morse code illustrated in FIG. 2. For brevity, similar descriptions for these embodiments are not repeated in detail here.

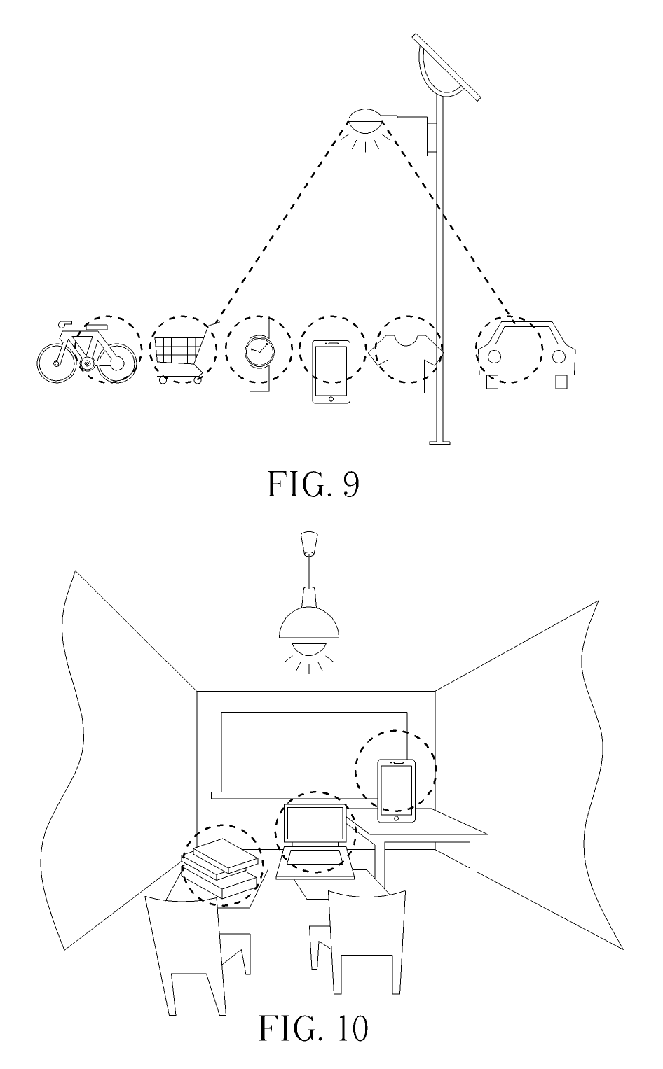

FIG. 9 illustrates a data broadcasting control scheme involved with the method shown in FIG. 3 according to an embodiment of the present invention. According to this embodiment, the plurality of devices may comprise a light system such as an outdoor light system. For example, the light system can be implemented as the data transmitter device, and the light shown in the topmost of FIG. 9 can be utilized as the light emitting component. The control circuit of the light system (e.g. a processor such as that mentioned above, and the associated peripheral circuits) may be integrated into the light shown in FIG. 9 or may be implemented with a server located somewhere else, for controlling data transmission of the light system according to the data delivery control scheme. In this embodiment, the data transmitter device may broadcast data (e.g. a silence command that requests the command receiver to keep silence, a slide, a link, a location information, etc.) and may deliver the data to multiple data receiver devices with the plurality of devices at the same time. For example, the data receiver devices may receive the data according to the data delivery control scheme. Examples of the data receiver devices may include, but not limited to, various types of electronic devices such as those shown around the bottommost of FIG. 9 (e.g. a bicycle, a cart, a watch such as the watch 100W, a mobile phone such as the multifunctional mobile phone 100M, a smart cloth, a car, etc.). For brevity, similar descriptions for this embodiment are not repeated in detail here.

According to some embodiments, the broadcasted data (e.g. the data broadcasted by the data transmitter device) may comprise one or a combination of a silence command that requests the command receiver (e.g. the electronic device) to keep silence, a slide, a link, a location information, etc. For brevity, similar descriptions for these embodiments are not repeated in detail here.

FIG. 10 illustrates a data broadcasting control scheme involved with the method shown in FIG. 3 according to another embodiment of the present invention. According to this embodiment, the plurality of devices may comprise a light system such as an indoor light system. For example, the light system can be implemented as the data transmitter device, and the light shown in the topmost of FIG. 10 can be utilized as the light emitting component. The control circuit of the light system (e.g. a processor such as that mentioned above, and the associated peripheral circuits) may be integrated into the light shown in FIG. 10 or may be implemented with a server located somewhere else, for controlling data transmission of the light system according to the data delivery control scheme. In this embodiment, the data transmitter device may broadcast data (e.g. a silence command that requests the command receiver to keep silence, a slide, a link, a location information, etc.) and may deliver the data to multiple data receiver devices with the plurality of devices at the same time. For example, the data receiver devices may receive the data according to the data delivery control scheme. Examples of the data receiver devices may include, but not limited to, various types of electronic devices such as those shown around the bottommost of FIG. 10 (e.g. smart or electronic books, a laptop computer, a tablet, etc.). For brevity, similar descriptions for this embodiment are not repeated in detail here.

The triggered operations mentioned above can be any operation the electronic device is able to perform, such as receiving data and storing the data, launching an application installed on the electronic device, keeping silence, waking up from a sleep mode thereof (e.g. a suspend mode such as a low power mode), switching on/off at least a portion of the electronic device or another electronic device, etc. According to some embodiments, the electronic device may enter the sleep mode (e.g. the suspend mode such as the low power mode), and may wake up upon trigger of the detected pattern. For example, the user may apply a touchless input such as that in some of the above embodiments to the electronic device (e.g. by shaking his/her hand around the ambient light sensor 10). For example, when the detected pattern matches the predetermined pattern, the pattern detection and trigger unit 114 may trigger the electronic device to wake up and enter a normal mode (e.g. a non-suspend mode such as a high power mode). As a result, in a situation where both hands of the user are dirty or wet and the user wants to do something with the electronic device, the processing circuit 110 may control the electronic device to perform the predetermined operation (e.g. waking up and turning on the display module, for example, to display something that has been or has not been previously displayed, such as a webpage, a document, a window, etc.), and the user does not need to touch the touch input module. For brevity, similar descriptions for these embodiments are not repeated in detail here.

According to some embodiments, the electronic device may enter a voice command mode upon trigger of the detected pattern. For example, when the detected pattern matches the predetermined pattern, the pattern detection and trigger unit 114 may trigger the electronic device to enter a voice command mode, to allow the electronic device to receive one or more voice commands from the user. As a result, in a situation where both hands of the user are dirty or wet and the user wants to do something with the electronic device, the processing circuit 110 may control the electronic device to perform the predetermined operation (e.g. receiving the one or more voice commands from the user), and the user does not need to touch the touch input module. For brevity, similar descriptions for these embodiments are not repeated in detail here.

According to some embodiments, the electronic device may enter the sleep mode and may wake up as described above. For example, when the detected pattern matches the predetermined pattern, the pattern detection and trigger unit 114 may trigger the electronic device to wake up and enter the voice command mode mentioned above, to allow the electronic device to receive one or more voice commands from the user. As a result, in a situation where both hands of the user are dirty or wet and the user wants to do something with the electronic device, the processing circuit 110 may control the electronic device to perform the predetermined operation (e.g. waking up and receiving the one or more voice commands from the user), and the user does not need to touch the touch input module. Please note that, as receiving voice commands typically needs a microphone, and as the microphone typically consumes much more power than the ambient light sensor 10, the processing circuit 110 may control the electronic device wait for a touchless input such as that in some of the above embodiments (rather than any voice command) in the sleep mode, to save power. For example, the processing circuit 110 may prevent tuning on the microphone until the voice command mode is entered upon trigger of the detected pattern. For brevity, similar descriptions for these embodiments are not repeated in detail here.

According to some embodiments, the electronic device may switch on or off upon trigger of the detected pattern. For example, when the detected pattern matches the predetermined pattern, the pattern detection and trigger unit 114 may trigger the electronic device to switch off (e.g. enter the sleep mode). In another example, when the detected pattern matches the predetermined pattern, the pattern detection and trigger unit 114 may trigger the electronic device to switch on (e.g. enter the normal mode). For brevity, similar descriptions for these embodiments are not repeated in detail here.

According to some embodiments, the electronic device may switch on or off at least a portion of the electronic device or another electronic device upon trigger of some detected patterns that are identified as different predetermined patterns within the plurality of predetermined patterns, respectively. For example, when the detected pattern matches a first predetermined pattern within the plurality of predetermined patterns, the pattern detection and trigger unit 114 may trigger the electronic device to switch off at least a portion of the electronic device or another electronic device (e.g. switching off the microphone of the electronic device, switching off the display module of the electronic device, switching off an air conditioner nearby, having the electronic device to enter the sleep mode, etc.). In another example, when the detected pattern matches a second predetermined pattern within the plurality of predetermined patterns, the pattern detection and trigger unit 114 may trigger the electronic device to switch on at least a portion of the electronic device or another electronic device. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling operations of an electronic device through ambient light detection, the method comprising the steps of:
utilizing an ambient light sensor of the electronic device to detect ambient light for the electronic device, to generate an ambient light detection signal, sampling the ambient light detection signal to convert the ambient light detection signal into a converted signal, and performing pattern detection on the converted signal to detect at least one pattern of the converted signal; and
according to a pattern and event database, determining whether the detected pattern of the converted signal matches a predetermined pattern within a plurality of predetermined patterns, to selectively trigger a predetermined operation associated with the predetermined pattern, wherein the pattern and event database stores the plurality of predetermined patterns.

2. The method of claim 1, wherein the pattern and event database stores a plurality of predetermined relationships between the plurality of predetermined patterns and a plurality of predetermined operations, wherein the predetermined operations are associated with the predetermined patterns, respectively.

3. The method of claim 1, wherein the step of determining whether the detected pattern of the converted signal matches the predetermined pattern within the plurality of predetermined patterns to selectively trigger the predetermined operation associated with the predetermined pattern further comprises:
when it is detected that the detected pattern matches the predetermined pattern, triggering the predetermined operation associated with the predetermined pattern.

4. The method of claim 1, further comprising:
performing pattern detection with aid of a single sensor, which is the ambient light sensor.

5. The method of claim 4, further comprising:
performing pattern detection with aid of the ambient light sensor, rather than any other sensor.

6. The method of claim 1, further comprising:
performing pattern detection with aid of the ambient light sensor, to receive data from another electronic device.

7. The method of claim 6, wherein the other electronic device comprises a light emitting component; and based on at least one portion of the plurality of predetermined patterns, the other electronic device modulates intensity of light of the light emitting component according to the data.

8. The method of claim 6, wherein the other electronic device broadcasts the data and delivers the data to multiple data receiver devices at a same time, and the electronic device is one of the multiple data receiver devices.

9. The method of claim 8, wherein the broadcasted data comprises one or a combination of a silence command that requests the electronic device to keep silence, a slide, a link, or a location information.

10. The method of claim 1, wherein at least one portion of the plurality of predetermined patterns comprises a set of pre-defined patterns, and another portion of the plurality of predetermined patterns comprises learned patterns generated by learning or training.

11. An apparatus for controlling operations of an electronic device through ambient light detection, the apparatus comprising:
an ambient light sensor, positioned in the electronic device, arranged for detecting ambient light for the electronic device, to generate an ambient light detection signal; and
a processing circuit, positioned in the electronic device and coupled to the ambient light sensor, arranged for sampling the ambient light detection signal to convert the ambient light detection signal into a converted signal, and performing pattern detection on the converted signal to detect at least one pattern of the converted signal, wherein according to a pattern and event database, the processing circuit determines whether the detected pattern of the converted signal matches a predetermined pattern within a plurality of predetermined patterns, to selectively trigger a predetermined operation associated with the predetermined pattern, wherein the pattern and event database stores the plurality of predetermined patterns.

12. The apparatus of claim 11, wherein the pattern and event database stores a plurality of predetermined relationships between the plurality of predetermined patterns and a plurality of predetermined operations, wherein the predetermined operations are associated with the predetermined patterns, respectively.

13. The apparatus of claim 11, wherein when it is detected that the detected pattern matches the predetermined pattern, the processing circuit triggers the predetermined operation associated with the predetermined pattern.

14. The apparatus of claim 11, wherein the processing circuit performs pattern detection with aid of a single sensor, which is the ambient light sensor.

15. The apparatus of claim 14, wherein the processing circuit performs pattern detection with aid of the ambient light sensor, rather than any other sensor.

16. The apparatus of claim 11, wherein the processing circuit performs pattern detection with aid of the ambient light sensor, to receive data from another electronic device.

17. The apparatus of claim 16, wherein the other electronic device comprises a light emitting component; and based on at least one portion of the plurality of predetermined patterns, the other electronic device modulates intensity of light of the light emitting component according to the data.

18. The apparatus of claim 16, wherein the other electronic device broadcasts the data and delivers the data to multiple data receiver devices at a same time, and the electronic device is one of the multiple data receiver devices.

19. The apparatus of claim 18, wherein the broadcasted data comprises one or a combination of a silence command that requests the electronic device to keep silence, a slide, a link, or a location information.

20. The apparatus of claim 11, wherein at least one portion of the plurality of predetermined patterns comprises a set of pre-defined patterns, and another portion of the plurality of predetermined patterns comprises learned patterns generated by learning or training.
